(19) United States
(12) Patent Application Publication
(10) Pub. No.: US 2015/0355862 A1
(43) Pub. Date: Dec. 10, 2015

(54) TRANSPARENT ARRAY MIGRATION

(71) Applicant: Pure Storage, Inc., Mountain View, CA (US)

(72) Inventors: John Hayes, Mountain View, CA (US); Par Botes, Mountain View, CA (US)

(21) Appl. No.: 14/296,170

(22) Filed: Jun. 4, 2014

(51) Int. Cl. G06F 3/06

(52) U.S. Cl. CPC G06F 3/0647; G06F 3/0689; G06F 3/0619

(57) ABSTRACT

A method for migrating data from a first storage array to a second storage array is provided. The method includes configuring the second storage array to forward requests to the first storage array and configuring a network so that second storage array assumes an identity of the first storage array. The method includes receiving a read request at the second storage array for a first data stored within the first storage array and transferring the first data through the second storage array to a client associated with the read request. The method is performed without reconfiguring the client. A system for migrating data is also provided.

### BACKGROUND

One of the more challenging tasks for customers and storage administrators is the migration from an older storage array to a new storage array. Current tools for data migration use mirroring, backup tools or file copy mechanisms. Typically these tools are applied during a scheduled outage and users cannot access the data being migrated during this outage. Even if data migration is scheduled at intervals of low user usage, which is rare, there can be issues with data coherency and performance. Data migration may take anywhere from days or weeks to a year or more depending on numerous parameters including the amount of data to be migrated and the available outage windows. Migrating large data sets requires long service outages or multi-staged approaches with full copy followed by subsequent partial re-sync of data which changed during initial transfer. During a large data migration, which may span a half a year to over a year, legacy equipment consumes floor space, power, cooling, and maintenance contract dollars. The financial cost during the migration period is a significant barrier for justification of an upgrade. Coordination amongst data owners and the data owner's tolerance for outages for tolerance and risk act as further impediments for upgrading to a new storage array.

The embodiments arise within this context.

### SUMMARY

In some embodiments, a method for migrating data from a first storage array to a second storage array is provided. The method includes configuring the second storage array to forward requests to the first storage array and configuring a network so that second storage array assumes an identity of the first storage array. The method includes receiving a read request at the second storage array for a first data stored within the first storage array and transferring the first data through the second storage array to a client associated with the read request. The method is performed without reconfiguring the client and wherein at least one method operation is executed by a processor.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram showing clients coupled to a legacy storage array and a migration storage array, in preparation for data migration in accordance with some embodiments.

FIG. 2 is a system diagram showing the legacy storage array coupled to the migration storage array, and the clients coupled to the migration storage array but decoupled from the legacy storage array, during data migration in accordance with some embodiments.

FIG. 3 is a system and data diagram showing communication between the legacy storage array and the migration storage array in accordance with some embodiments.

FIG. 4 is a flow diagram showing aspects of a method of migrating data, which can be practiced using embodiments shown in FIGS. 1-3.

FIG. 5 is a flow diagram showing further aspects of a method of migrating data, which can be practiced using embodiments shown in FIGS. 1-3.

FIG. 6 is a block diagram showing a storage cluster that may be integrated as a migration storage array in some embodiments.

FIG. 7 is an illustration showing an exemplary computing device which may implement the embodiments described herein.

### DETAILED DESCRIPTION

The embodiments provide for a transparent or non-disruptive array migration for storage systems. The migration storage array couples to a legacy storage array and migrates data from the legacy storage array to the migration storage array. Unlike traditional data migration with outages, clients can access data during the migration. The migration storage array maintains a copy of the filesystem from the legacy storage array. The migration storage array assumes the network identity of the legacy storage array and data not yet copied to the migration storage array during a migration time span is delivered to a requestor from the legacy storage array through the migration storage array. The data sent to the client is written to the migration storage array. Client access is decoupled from the legacy storage array, and redirected to the migration storage array. Clients can access data at the migration storage array that has been copied or moved from the legacy storage array. Clients write new data to the migration storage array, and this data is not copied into the legacy storage array. The migration storage array retrieves all the metadata for the legacy storage array so that the migration storage array becomes the authority for all client access and inode caching. In some embodiments the metadata transfer occurs prior to the transfer of user data from the legacy storage array to the migration storage array. The metadata is initialized to “copy on read”, and updated with client accesses and as data is moved from the legacy storage array to the migration storage array. The metadata may be initialized to copy data on a read request from one of the clients or an internal policy of the system in some embodiments.

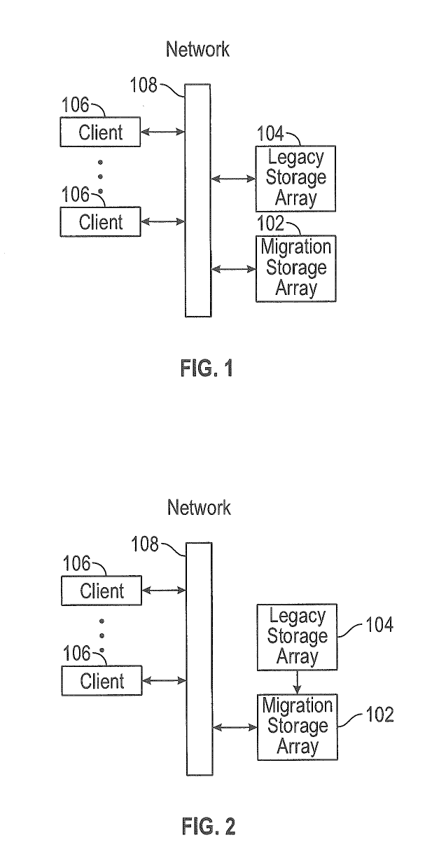

FIG. 1 is a system diagram showing clients 106 coupled to a legacy storage array 104 and a migration storage array 102 by a network 108, in preparation for data migration. The legacy storage array 104 can be any type of storage array or storage memory on which relatively large amounts of data reside. The legacy storage array 104 is the source of the data for the data migration. The legacy storage array 104 may be network attached storage (NAS) in some embodiments although this is one example and not meant to be limiting. The migration storage array 102 can be a storage array or storage memory having a storage capacity that may or may not be greater than the storage capacity of the legacy storage array 104. In various embodiments, the migration storage array 102 can be a physical storage array, or a virtual storage array configured from physical storage. The migration storage array 102 can have any suitable storage class memory, such as flash memory, spinning media such as hard drives or optical disks, combinations of storage class memory, and/or other types of storage memory. In some embodiments the migration storage array 102 can employ data striping, RAID (redundant array of independent disks) schemes, and/or error correction. In FIG. 1, clients 106 are reading and writing data in the legacy storage array 104 through network 108. Clients 106 can communicate with the migration storage array 102 to set up parameters and initiate data migration. In some embodiments, the migration storage array 102 is given a name on the network 108 and provided instructions for coupling to or communicating with the legacy storage array 104, e.g., via the network 108 or via a direct coupling. Other couplings between the migration storage array 102 and the legacy storage array 104 are readily devised. Further, the network 108 could include multiple networks, and could include wired or wireless networks.

FIG. 2 is a system diagram showing the legacy storage array 104 coupled to the migration storage array 102 in accordance with some embodiments. Clients 106 are coupled to the migration storage array 102 via network 108. In preparation for a migration of data, clients 106 are decoupled from the legacy storage array 104 through various techniques. These techniques include disconnecting the legacy storage array 104 from the network 108, leaving the legacy storage array 104 coupled to the network 108 but denying access to clients 106, or otherwise stopping clients 106 access to the legacy storage array 104. The migration storage array 102 could be coupled to the legacy storage array 104 by a direct connection, such as with cabling, or could be coupled via the network 108 or via multiple networks. The migration storage array 102 is the only client or system that can access the legacy storage array 104 during the data migration in some embodiments. Exception to this could be made for system administration or other circumstances. In some embodiments, client access to the legacy storage array 104 is disconnected and remapped to the migration storage array 102 through network redirection or other techniques mentioned below. Migration storage array 102 assumes the identity of the legacy storage array 104 in some embodiments. The identity may be referred to as a public identity in some embodiments. The migration of the data proceeds through migration storage array 102 in a manner that allows an end user full access to the data during the process of the data being migrated.

There are multiple techniques for changing from the client 106 coupling to the legacy storage array 104 to the client 106 coupling to the migration storage array 102. In one embodiment, the network 108 redirects attempts by the client 106 to communicate with the legacy storage array 104 to the migration storage array 102. This could be implemented using network switches or routers, a network redirector, or network address translation. In one embodiment, an IP (Internet Protocol) address and/or a MAC address belonging to the legacy storage array 104 is reassigned from the legacy storage array 104 to the migration storage array 102. In other embodiments the network may be configured to reassign a host name, reassign a domain name, or reassign a NetBIOS name. The client 106 continues to make read or write requests using the same IP address or MAC address, but these requests would then be routed to the migration storage array 102 instead of the legacy storage array 104. The legacy storage array 104 could then be given a new IP address and/or MAC address, and this could be used by the migration storage array 102 to couple to and communicate with the legacy storage array 104. The migration storage array 102 takes over the IP address and/or the MAC address of the legacy storage array 104 to assume the identity of the legacy storage array. The migration storage array 102 is configured to forward requests received from clients 106 to legacy storage array 104. In one embodiment, there is a remounting at the client 106 to point to the migration storage array 102 and enable access to the files of the migration storage array. The client 106 could optionally unmount the legacy storage array 104 and then mount the migration storage array 102 in some embodiments. In this manner, the client 106 accesses the (newly mounted) migration storage array 102 for storage, instead of accessing the legacy storage array 104 for storage. In any of the various techniques described above, the migration storage array 102 emulates the legacy storage array 104 at the protocol level. In some embodiments, the operating system of the legacy storage array 104 and the operating system of the migration storage array 102 are different.

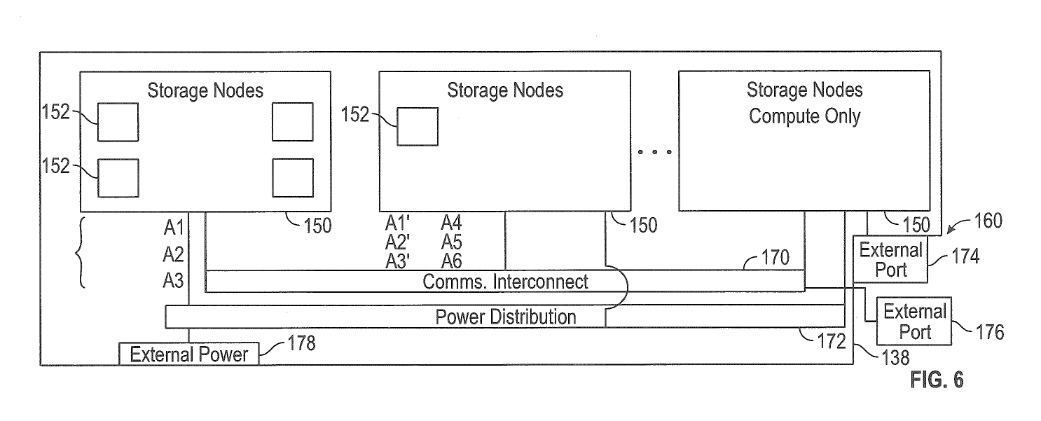

The above embodiments can be visualized with the aid of FIG. 1, which has the legacy storage array 104 and the migration storage array 102 coupled to the network 108. However, the communication paths change with application of the above mechanisms. Specifically, the communication path for the client 106 to access storage changes from the client 106 communicating with the legacy storage array 104, to the client 106 communicating with the migration storage array 102. In virtualization systems, IP addresses, MAC addresses, virtual local area network (VLAN) configurations and other coupling mechanisms can be changed in software, e.g., as parameters. In the embodiment represented by FIG. 2, a direct coupling to the migration storage array 102 could be arranged via an IP port in a storage cluster, a storage node, or a solid-state storage, such as an external port of the storage cluster of FIG. 6. The embodiments enable data migration to be accomplished without reconfiguring the client 106. In some embodiments, clients 106 are mounted to access the filesystem of the migration storage array 102, however, the mounting operation is not considered a reconfiguration of the client 106. Reassigning an IP address or a MAC address from a legacy storage array 104 to a migration storage array 102 and arranging a network redirection also do not require any changes to the configuration of the client 106 as the network is configured to address these changes. In these embodiments, the only equipment that is reconfigured is the legacy storage array 104 or the network.

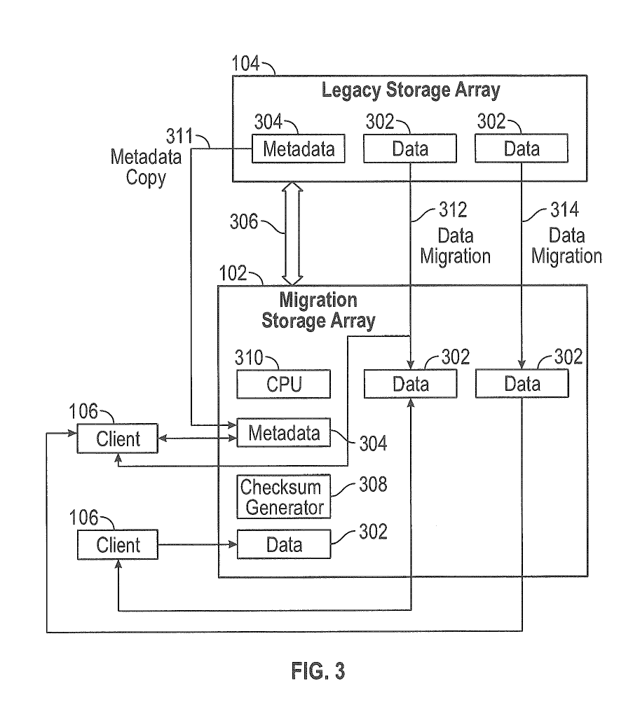

FIG. 3 is a system and data diagram showing communication between the legacy storage array 104 and the migration storage array 102 according to some embodiments. Communication between the migration storage array 102 and the legacy storage array 104 occurs over a bidirectional communication path 306, which allows requests, handshaking, queries or the like to be communicated in either direction. Metadata copy and data migration are shown as unidirectional arrows, as generally the metadata 304 and the data 302 flow from the legacy storage array 104 to the migration storage array 102. An exception to this could be made if the data migration fails and client writes have occurred during the data migration, in which case the legacy storage array 104 may be updated in some embodiments.

The migration storage array 102 reads or copies metadata 304 from the legacy storage array 104 into the migration storage array 102 of FIG. 3. This metadata copy is indicated by line 311 coupling the metadata 304 in the legacy storage array 104 to the metadata 304 in the migration storage array 102. The metadata 304 includes information about the data 302 stored on the legacy storage array 104. In some embodiments the migration storage array 102 copies the filesystem from the legacy storage array 104 so as to reproduce and maintain the filesystem locally at the migration storage array 102. In some embodiments a file share or a directory hierarchy may be reproduced in the migration storage array 102. By using a local copy or version of the filesystem, the migration storage array 102 can create identical file system exports as would be available on the legacy storage array 104. The filesystem may be copied as part of the metadata copy or as a separate operation. In some embodiments the metadata 304 is copied prior to migration of any user data. Typically metadata 304 is a significantly smaller in size than the user data and can be copied relatively quickly.

Initially, the migration storage array 102 marks the metadata 304 on the migration storage array 102 as “copy on read”. “Copy on read” refers to process where the migration storage array 102 reads data 302 from the legacy storage array 104 in response to a client request for the data 302. The data 302 accessed from the read is also copied into the migration storage array. A processor executing on the migration storage array 102 or a processor coupled to the migration storage array may execute the copy on read process in some embodiments. Such operations are further explained below, with details as to interactions among clients 106, data 302, and metadata 304, under control of the migration storage array 102. Data 302 may have various forms and formats, such as files, blocks, segments, etc. In some embodiments, the copying and setup of the metadata 304 takes place during a system outage in which no client traffic is allowed to the legacy storage array 104 and no client traffic is allowed to the migration storage array 102.

During the data migration time span, the migration storage array 102 copies data from the legacy storage array 104 into the migration storage array 102. This data migration is indicated in FIG. 3 as arrows 312 and 314 from data 302 in the legacy storage array 104 to data 302 in the migration storage array 102. For example, the migration storage array 102 could read the data 302 from the legacy storage array 104, and write the data 302 into the migration storage array 102 for migration of the data. During the data migration, clients 106 have full access to the data. Where data has not been copied to migration storage array 102 and a client 106 requests a copy of that data, the data is accessed from the legacy storage array 104 via the migration storage array as illustrated by line 312 and as discussed above. If a client 106 reads data 302 that has been copied from the legacy storage array 104 into the migration storage array 102, the migration storage array 102 sends a copy of the data 302 to the client 106 directly from the migration storage array 102. If a client 106 writes data 302 that has been copied from the legacy storage array 104 into the migration storage array 102, e.g., after reading the data 302 from the migration storage array 102 and editing the data 302, the migration storage array 102 writes the data 302 back into the migration storage array 102 and updates the metadata 304.

The copy on read takes place when data 302 has not yet been copied from the legacy storage array 104 to the migration storage array 102. Since the data 302 is not yet in the migration storage array 102, the migration storage array 102 reads the data 302 from the legacy storage array 104. The migration storage array 102 sends the data 302 to the client 106, and writes a copy of the data 302 into the migration storage array 102. After doing so, the migration storage array 102 updates the metadata 304 in the migration storage array 102, to cancel the copy on read for that data 302. In some embodiments the copy on read for data 302 is cancelled responsive to overwriting data 302. The data 302 is then treated as data that has been copied from the legacy storage array 104 into the migration storage array 102, as described above. If a client 106 writes data 302, the migration storage array 102 writes the data 302 into the migration storage array 102. This data 302 is not copied or written into the legacy storage array 104 in some embodiments. The migration storage array 102 updates the metadata 304 in the migration storage array 102, in order to record that the new data 302 that has been written to the migration storage array 102.

If a client 106 deletes data 302, the migration storage array 102 updates the metadata 304 in the migration storage array 102 to record the deletion. For example, if the data 302 was already moved from the legacy storage array 104 into the migration storage array 102, reference to this location in the migration storage array 102 is deleted in the metadata 304 and that amount of storage space in the migration storage array 102 can be reallocated. In some embodiments, the metadata 304 in the migration storage array 102 is updated to indicate that the data is deleted, but is still available in the migration storage array 102 for recovery. If the data 302 has not already been moved from the legacy storage array 104 into the migration storage array 102, the update to the metadata 304 could cancel the move, or could schedule the move into a “recycle bin” in case the data needs to be later recovered. The update to the metadata 304 could also indicate that the copy on read is no longer in effect for that data 302.

If a client 106 makes changes to the filesystem, the changes can be handled by the migration storage array 102 updating the metadata 304 in the migration storage array 102. For example, directory changes, file or other data permission changes, version management, etc., are handled by the client 106 reading and writing metadata 304 in the migration storage array 102, with oversight by the migration storage array 102. A processor 310, e.g., a central processing unit (CPU), coupled to or included in the migration storage array 102 can be configured to perform the above-described actions. For example, software resident in memory could include instructions to perform various actions. Hardware, firmware and software can be used in various combinations as part of a configuration of the migration storage array 102. In some embodiments, the migration storage array 102 includes a checksum generator 308. The checksum generator 308 generates a checksum of data 302. The checksum could be on a basis of a file, a group of files, a block, a group of blocks, a directory structure, a time span or other basis as readily devised. This checksum can be used for verification of data migration, while the data migration is in progress or after completion.

Various additional services could be performed by the processor 310. Migration could be coordinated with an episodic replication cycle, which could be tuned to approximate real-time replication, e.g., mirroring or backups. If a data migration fails, the legacy storage array 104 offers a natural snapshot for rollback since the legacy storage array 104 is essentially read-only during migration. Depending on whether data migration is restarted immediately after a failure, client 106 access to the legacy storage array 104 could be reinstated for a specified time. If clients 106 have written data to the migration storage array 102 during the data migration, this data could be written back into the legacy storage array 104 in some embodiments. One mechanism to accomplish this feature is to declare data written to the migration storage array 102 during data migration as restore objects, and then use a backup application tuned for restoring incremental delta changes. For audits and compliance, an administrator could generate checksums ahead of time and the checksums could be compared as files are moved, in order to generate an auditable report. Checksums could be implemented for data and for metadata. In some embodiments a tool could generate checksums of critical data to prove data wasn't altered during the transfer.

Preferential identification and migration of data could be performed, in some embodiments. For example, highly used data could be identified and migrated first. As a further example, most recently used data could be identified and migrated first. A fingerprint file, as used in deduplication, could be employed to identify frequently referenced portions of data and the frequently referenced portion of the data could be migrated first or assigned a higher priority during the migration. Various combinations of identifying data that is to be preferentially migrated are readily devised in accordance with the teachings herein.

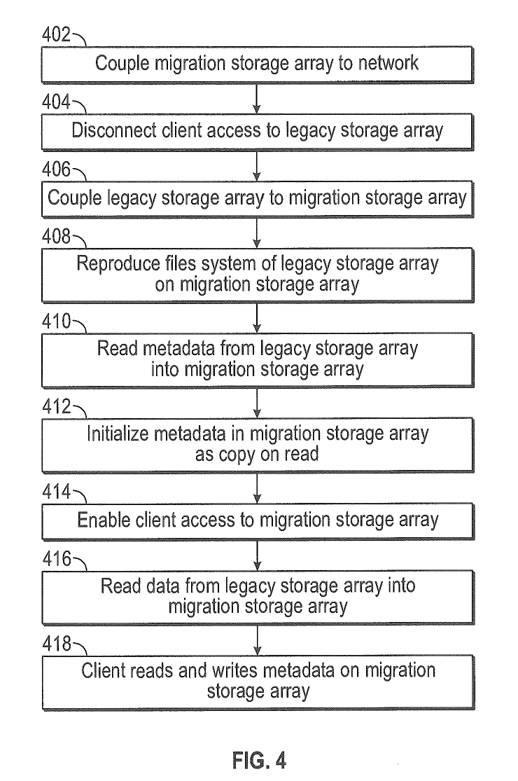

FIG. 4 is a flow diagram showing aspects of a method of migrating data, which can be practiced using embodiments shown in FIGS. 1-3. A migration storage array is coupled to a network, in an action 402. In some embodiments, the migration storage array is a flash based storage array, although any storage class medium may be utilized. Client access to a legacy storage array is disconnected, in an action 404. For example, the legacy storage array could be disconnected from the network, or the legacy storage array could remain connected to the network but client access is denied or redirected.

In an action 406, the legacy storage array is coupled to the migration storage array. The coupling of the arrays may be through a direct connection or a network connection. The filesystem of the legacy storage array is reproduced on the migration storage array, in an action 408. In the action 410, metadata is read from the legacy storage array into the migration storage array. The metadata provides details regarding the user data stored on the legacy storage array and destined for migration. In some embodiments, the metadata and filesystem are copied to the migration array prior to any migration of user data. In addition, action 408 may be performed in combination with action 410. The metadata in the migration storage array is initialized as copy on read, in an action 412 to indicate data that has been accessed through the migration storage array but has not yet been stored on the migration storage array.

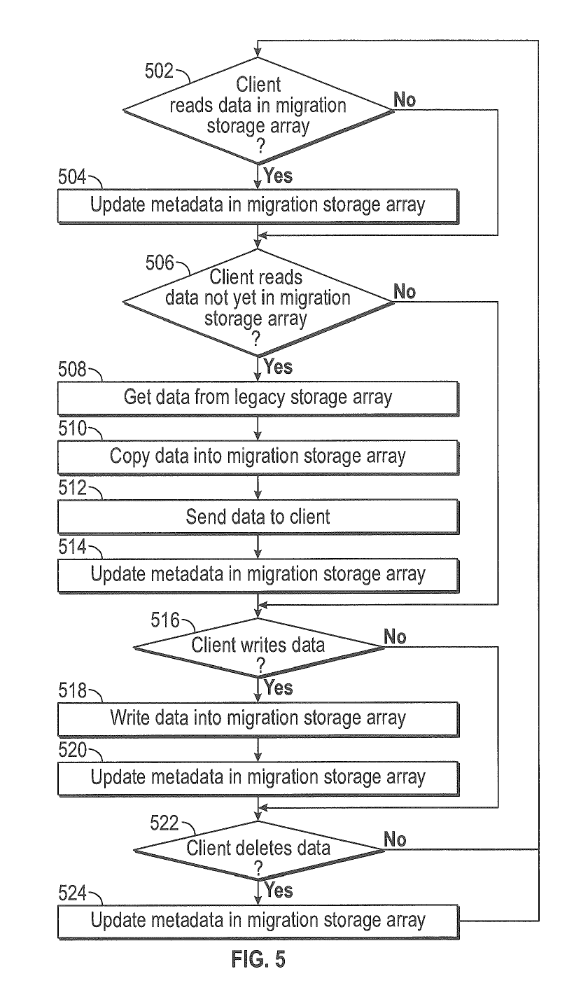

Client access to the migration storage array is enabled in an action 414. For example, the permissions could be set so that clients are allowed access or the clients can be mounted to the migration storage array after assigning the identity of the legacy storage array to the migration storage array. Data is read from the legacy storage array into the migration storage array, in an action 416. Action 416 takes place during the data migration or data migration time span, which may last for an extended period of time or be periodic. During the data migration time span, the client can read and write metadata on the migration storage array, in the action 418. For example, the client could make updates to the directory information in the filesystem, moving or deleting files. Further actions in the method of migrating data are discussed below with reference to FIG. 5.

FIG. 5 is a flow diagram showing further aspects of a method of migrating data, which can be practiced using embodiments shown in FIGS. 1-3. These actions can be performed in various orders, during the data migration time span. For example, the questions regarding client activity could be asked in various orders or in parallel, or the system could be demand-based or multithreaded, etc. In a decision action 502, it is determined if the client is reading data in the migration storage array. In this instance a specific data has already been moved from the legacy storage array to the migration storage array, and the client requests to read that data. If the client is not reading data in the migration storage array, the flow branches to the decision action 506. If the client is reading data in the migration storage array, flow proceeds to the action 504, in which the metadata in the migration storage array is updated to indicate a client read of this data. In some embodiments, the metadata would not be updated in this instance.

In a decision action 506, it is determined if the client is reading data not yet in the migration storage array. In this instance, a specific data requested for a client read has not yet been moved from the legacy storage array to the migration storage array. If the client is reading data in the migration storage array, the flow branches to the decision action 516. If the client is reading data not yet in the migration storage array, flow proceeds to the action 508, for the copy on read process. The migration storage array (or a processor coupled to the migration storage array) obtains the data requested by the client read from the legacy storage array, in the action 508. The data is copied into the migration storage array, in an action 510 and the data is sent to the client, in an action 512. Actions 510 and 512 may occur contemporaneously. The metadata is updated in the migration storage array, in an action 514. For example, the copy on read directive pertaining to this particular data could be canceled in the metadata after the copy on read operation is complete. Cancelling the copy on read directive indicates that no further accesses to the legacy storage array are needed to obtain this particular data. Actions 510, 512, 514 could be performed in various orders, or at least partially in parallel.

In a decision action 516, it is determined if a client is requesting a write operation. If the client is not requesting a write operation, flow branches to the decision action 522. If the client is requesting a write operation, flow proceeds to the action 518. The data is written into the migration storage array, in the action 518. The metadata is updated in the migration storage array, in the action 520. For example, metadata could be updated to indicate the write has taken place and to indicate the location of the newly written data in the migration storage array, such as by updating the reproduced filesystem. In a decision action 522, it is determined if the client is requesting that data be deleted. If the client is not deleting data, flow branches back to the decision action 502. If the client is deleting data, flow proceeds to the action 524. In the action 524, the metadata is updated in the migration storage array. For example, the metadata could be updated to delete reference to the deleted data, or to show that the data has the status of deleted, but could be recovered if requested. The metadata may be updated to indicate that the data does not need to be copied from the legacy storage array to the migration storage array, in the case that the copy on read directive is still in effect and the data was not yet moved. Flow then proceeds to the decision action 502 and repeats as described above.

FIG. 6 is a block diagram showing a communications interconnect 170 and power distribution bus 172 coupling multiple storage nodes 150 of storage cluster 160. Where multiple storage clusters 160 occupy a rack, the communications interconnect 170 can be included in or implemented with a top of rack switch, in some embodiments. As illustrated in FIG. 6, storage cluster 160 is enclosed within a single chassis 138. Storage cluster 160 may be utilized as a migration storage array in some embodiments. External port 176 is coupled to storage nodes 150 through communications interconnect 170, while external port 174 is coupled directly to a storage node. In some embodiments external port 176 may be utilized to couple a legacy storage array to storage cluster 160. External power port 178 is coupled to power distribution bus 172. Storage nodes 150 may include varying amounts and differing capacities of non-volatile solid state storage. In addition, one or more storage nodes 150 may be a compute only storage node. Authorities 168 are implemented on the non-volatile solid state storages 152, for example as lists or other data structures stored in memory. In some embodiments the authorities are stored within the non-volatile solid state storage 152 and supported by software executing on a controller or other processor of the non-volatile solid state storage 152. Authorities 168 control how and where data is stored in the non-volatile solid state storages 152 in some embodiments. This control assists in determining which type of erasure coding scheme is applied to the data, and which storage nodes 150 have which portions of the data.

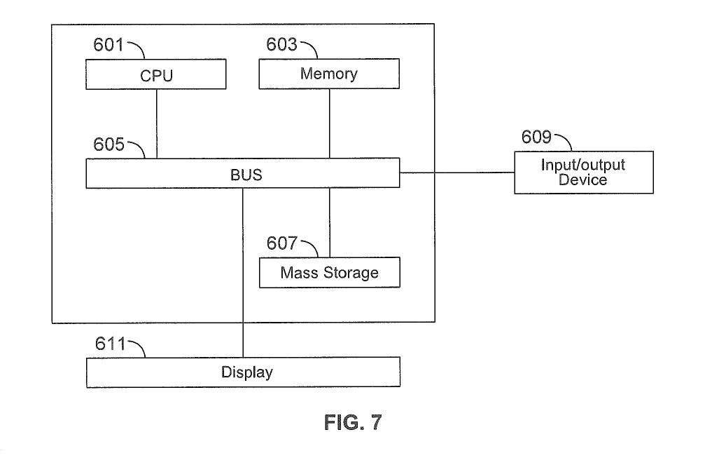

It should be appreciated that the methods described herein may be performed with a digital processing system, such as a conventional, general-purpose computer system. Special purpose computers, which are designed or programmed to perform only one function may be used in the alternative. FIG. 7 is an illustration showing an exemplary computing device which may implement the embodiments described herein. The computing device of FIG. 7 may be used to perform embodiments of the functionality for migrating data in accordance with some embodiments. The computing device includes a central processing unit (CPU) 601, which is coupled through a bus 605 to a memory 603, and mass storage device 607. Mass storage device 607 represents a persistent data storage device such as a floppy disc drive or a fixed disc drive, which may be local or remote in some embodiments. The mass storage device 607 could implement a backup storage, in some embodiments. Memory 603 may include read only memory, random access memory, etc. Applications resident on the computing device may be stored on or accessed via a computer readable medium such as memory 603 or mass storage device 607 in some embodiments. Applications may also be in the form of modulated electronic signals modulated accessed via a network modem or other network interface of the computing device. It should be appreciated that CPU 601 may be embodied in a general-purpose processor, a special purpose processor, or a specially programmed logic device in some embodiments.

Display 611 is in communication with CPU 601, memory 603, and mass storage device 607, through bus 605. Display 611 is configured to display any visualization tools or reports associated with the system described herein. Input/output device 609 is coupled to bus 605 in order to communicate information in command selections to CPU 601. It should be appreciated that data to and from external devices may be communicated through the input/output device 609. CPU 601 can be defined to execute the functionality described herein to enable the functionality described with reference to FIGS. 1-6. The code embodying this functionality may be stored within memory 603 or mass storage device 607 for execution by a processor such as CPU 601 in some embodiments. The operating system on the computing device may be MS DOS™, MS-WINDOWS™, OS/2™, UNIX™, LINUX™, or other known operating systems. It should be appreciated that the embodiments described herein may be integrated with virtualized computing system also.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” perform a task or tasks. In such contexts, the phrase “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method for migrating data from a first storage array to a second storage array, comprising:
configuring the first storage array to respond to requests from the second storage array;
configuring a network so that the second storage array assumes an identity of the first storage array;
receiving a read request at the second storage array for a first data stored within the first storage array; and
transferring the first data through the second storage array to a client associated with the read request, wherein the method is performed without reconfiguring the client and wherein at least one method operation is executed by a processor.

2. The method of claim 1, further comprising:
copying metadata from the first storage array to the second storage array;
initializing the metadata, in the second storage array, as to a copy data on read request from one of clients or a policy; and
canceling the copy on read policy for the first data, in the metadata in the second storage array, responsive to one of storing or overwriting the first data in the second storage array.

3. The method of claim 1, further comprising:
storing the first data in the second storage array after receiving the read request.

4. The method of claim 1, wherein a storage capacity of the second storage array is greater than a storage capacity of the first storage array.

5. The method of claim 1, wherein configuring the network, comprises:
assigning the identity of the first storage array to the second storage array; and
assigning a new identity to the first storage array.

6. The method of claim 1, wherein transferring the first data through the second storage array comprises:
writing the first data into the second storage array.

7. A method for migrating data, comprising:
coupling a first storage array to a second storage array;
configuring the first storage array to forward requests to the second storage array;
configuring a network so that the first storage array assumes an identity of the second storage array;
receiving a read request at the first storage array for a first data stored within the second storage array; and
transferring the first data from the second storage array through the first storage array to a client associated with the read request during a data migration time span, wherein the method is performed without reconfiguring the client and wherein at least one method operation is executed by a processor.

8. The method of claim 7, further comprising:
moving data from the second storage array into the first storage array, during the data migration time span.

9. The method of claim 7, further comprising:
writing the first data into the first storage array;
reading the first data from the first storage array, responsive to a second client request for reading the first data; and
sending the first data to the second client from the first storage array.

10. The method of claim 7, further comprising:
reading a second data from the first storage array, responsive to a third client request for reading the second data and the second data having been moved from the second storage array into the first storage array; and
sending the second data to the third client from the first storage array.

11. The method of claim 7, further comprising:
reading metadata from the second storage array;
writing the metadata from the second storage array into the first storage array prior to moving the data from the second storage array; and
marking at least a portion of the metadata, in the first storage array, as copy on read, wherein writing the first data into the first storage array is in accordance with the copy on read.

12. The method of claim 7, wherein configuring the network so that the first storage array assumes the identity of the second storage array comprises at least one of a network redirect, reassigning an IP (Internet Protocol) address from the second storage array to the first storage array, reassigning a MAC (media access control) address, reassigning a host name, reassigning a domain name, or re-assigning a NetBIOS name from the second storage array to the first storage array.

13. The method of claim 7, wherein a storage media of the second storage array is different than a first media of the migration storage array.

14. The method of claim 11, further comprising:
updating metadata in the first storage array, responsive to a request to delete data.

15. The method of claim 7, further comprising:
reproducing one of a filesystem, a file share or a directory hierarchy of the second storage array on the first storage array.

16. A system for transparent array migration, comprising:
a first storage memory, having sufficient capacity to store data migrated from a second storage memory; and
at least one processor, coupled to the first storage memory, and configured to perform actions including:
configuring the first storage memory to forward requests to the second storage memory;
configuring a network so that first storage memory assumes an identity of the second storage memory;
receiving a read request at the first storage memory for a first data stored within the second storage memory; and
transferring the first data through the first storage memory to a client associated with the read request, wherein the actions are performed without reconfiguring the client.

17. The system of claim 16, wherein the first storage memory includes flash memory as at least a majority of a storage capacity of the first storage memory.

18. The system of claim 16, wherein the actions further comprise:
storing a reproduction of one of a filesystem, a file share, or a directory hierarchy of the second storage memory in the first storage memory.

19. The system of claim 16, further comprising:
the first storage memory configured to store metadata, wherein the actions further include:
storing a copy of metadata of the second storage memory as the metadata in the first storage memory; and
updating the metadata in the first storage memory, responsive to data access in the first storage memory by the client, and responsive to the moving further data.

20. The system of claim 16, further comprising:
a checksum generator, configured to generate a checksum relative to the further data, wherein the checksum is applicable to verification of a data migration from the second storage memory to the first storage memory.
